(19) United States
(12) Patent Application Publication
(10) Pub. No.: US 2026/0280932 A1
(43) Pub. Date: Sep. 17, 2026

(54) SYSTEM AND METHODS FOR SECURING CONTROLLER AREA NETWORK USING INTERFRAME SPACING

(71) Applicant: Purdue Research Foundation, West Lafayette, IN (US)

(72) Inventors: Khaled Serag Alsharif, West Lafayette, IN (US); Dongyan Xu, West Lafayette, IN (US); Zeynel Berkay Celik, West Lafayette, IN (US); Vireshwar Kumar, New Delhi, Delhi (IN)

(21) Appl. No.: 19/042,369

(22) Filed: Jan. 31, 2025

Related U.S. Application Data
(60) Provisional application No. 63/627,482, filed on Jan. 31, 2024.

(51) Int. Cl. H04L 12/40

(52) U.S. Cl. CPC H04L 12/40104; H04L 12/40013; H04L 2012/40215

(57) ABSTRACT

A first node may broadcast messages on a controller area network (CAN) bus. A second node may listen for the messages on the CAN bus. The first node may include spacing at a start of the messages and set a length of the spacing for each of the messages, respectively, according to a predetermined sequence of lengths. The second node may an identify of the node based on the length of the spacing at the start of each of the messages using the predetermined sequence of lengths.

### RELATED APPLICATION

This application claims the benefit of U.S. Provisional Application No. 63/627,482 filed Jan. 31, 2024, the entirety of which is incorporated by reference.

### GOVERNMENT RIGHTS

This invention was made with government support under N00014-22-1-2671 and N00014-18-1-2674 awarded by the Office of Naval Research. The government has certain rights in the invention.

### TECHNICAL FIELD

This disclosure relates to serial communication and, in particular, to secure communication over a controller area network.

### BACKGROUND

Controller Area Network (CAN) is a widely used network protocol. In addition to being the main communication medium for vehicles, it is also used in factories, medical equipment, elevators, and avionics. Unfortunately, CAN was designed without any security features. Consequently, it has come under scrutiny by the research community, showing its security weakness. Recent works have shown that a single compromised ECU on a CAN bus can launch a multitude of attacks ranging from message injection, to bus flooding, to attacks exploiting CAN's error handling mechanism. Although several works have attempted to secure CAN, we argue that none of their approaches could be widely adopted for reasons inherent in their design. In this work, we introduce ZBCAN, a defense system that uses zero bytes of the CAN frame to secure against the most common CAN attacks, including message injection, impersonation, flooding, and error handling, without using encryption or MACs, while taking into consideration performance metrics such as delay, busload, and data-rate.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a system 100 for securing a controller area network (CAN).

FIG. 2 illustrates an example of a can utilizing zero-byte spacing in between frames.

FIG. 3 illustrates an example of a running IBN sequence as a message ID signature.

FIG. 4 illustrates dividing a timeline into distances=|IBNSpan| for using Modulo IBN instead of Absolute IBN.

FIG. 5 illustrates an example of dividing IBNSpan into exclusive priority spans.

FIG. 6 illustrates an example of how successively interrupting error frame delimiters instantly pushes transmitters to the bus-off state.

FIG. 7 illustrates an example of an electronic control unit (ECU).

FIG. 8 illustrates an example of CAN frame fields of two back-to-back frames.

FIG. 9 illustrates an example of collision injection.

FIG. 10 illustrates a second example of a system.

### DETAILED DESCRIPTION

Modern vehicles contain hundreds of sensors and actuators, administered by Electronic Control Units (ECUs), including brake, engine, and steering control units. The most central communication channel among ECUs is CAN. Although reliable and robust against electromagnetic interference, CAN lacks any security measures. Researchers have demonstrated the feasibility of remotely compromising an ECU on the CAN bus. With the ever-increasing connectivity of today's vehicles, the ease of such compromises is expected to increase. Several works have shown that a compromised ECU can launch a plethora of attacks, including message injection, impersonation, and flooding. Moreover, recent works have unveiled vulnerabilities in CAN's error handling mechanism. These vulnerabilities allow attackers to deliberately inject collisions, map message sources, control the error states of certain ECUs or even persistently disable them.

To secure CAN traffic, two primary approaches have been proposed. One is the cryptographic approach, which relies heavily on cryptographic primitives (e.g., encryption, MACs, and hash functions). Unfortunately, this approach suffers from fundamental issues. The first is its impact on performance as cryptographic operations incur an unaffordable processing overhead for most commercial ECUs. Even worse, since the maximum payload length of a CAN message is 64 bits, these solutions are forced to either carve out a portion of an already-short message to attach authentication information, dropping the effective data rate, or use a completely different message, doubling the busload. Another issue is the lack of intrusion confinement. Since most of these solutions use group keys, if one ECU gets compromised, it can impersonate any node in the group. The last downside is the lack of incremental deployability or the ability to incrementally secure messages transmitted by a single ECU, without needing to update all ECUs at once.

The second approach is the intrusion detection (IDS) approach, which avoids the group-key problems and the computationally expensive cryptographic operations by delegating all security operations to a super-node that may have special equipment. This powerful node uses its abilities to detect traffic anomalies and flag them. However, this approach has its problems. First, IDSs take no measure to stop or prevent attacks. Second, most CAN IDSs do not achieve single-message detection. Instead, they retrospectively detect flows of injected messages. This allows intermittent or gradual intrusions to pass unnoticed and contributes to these IDSs' inability to translate their attack detection into prevention, for a flow of messages is composed of a stream of individual messages. Being unable to determine whether an individual message is malicious or not prevents the IDS from taking action against any of the individual malicious messages that constitute the flow.

Additionally, the entire research field suffers from a hyperfocus phenomena. A relatively vast amount of research has been dedicated to message injection and its variations in comparison with other attacks. Further, many defenses contradict one another and thus cannot be combined to protect against a more extensive attack-set. These problems have prevented any defense from being widely adopted.

We present Zero-Byte CAN, a versatile, low-overhead defense system that uses zero bytes of the CAN message fields to protect against several attacks and offers intrusion confinement, incremental deployability, full backward compatibility, and individual message guarantees. This last feature allows ZBCAN to translate some of its detection abilities, into prevention ones, since individual malicious messages could be identified and stopped. ZBCAN does not use message fields, authentication messages, or computationally expensive operations such as encryption. Instead, it uses message timing alone to protect against the most common CAN attacks, including injection, impersonation, fuzzing, flooding, collision injection, voltage corruption, and bus-off.

ZBCAN is composed of a trusted officer node that can interrupt transmission and several software agents, installed on ECUs. The officer and each agent agree on a secret, endless, and dynamically generated sequence of inter-frame spaces, which the officer monitors for every message. The officer could be set to issue warnings, interrupt messages, or completely suspend violating nodes. Aside from attaching the officer to the bus, ZBCAN does not require any hardware changes. Further, since ZBCAN uses no message fields, it could be combined with solutions that do use them. For inclusivity, we evaluated ZBCAN's performance on a testbed using a real vehicle's data, its security and scalability on a testbed using artificial data, and finally, several security and performance aspects of ZBCAN on a real vehicle. Using ZBCAN, we achieved a detection rate of 100% for injection and replay attacks, and prevention rates of 100%, 100%, 99.4%, 99.33%, and 98.5% for error-passive, bus-off, collision injection, flooding, and injection attacks, respectively. We summarize our contributions as follows:

We present ZBCAN, a versatile defense system that uses inter-frame spaces to defend against the most common CAN attacks, offering both detection and prevention abilities.

We introduce a new method to suspend any ECU as soon as it starts transmitting a frame called Instant Bus-Off. This method could be used to suspend intruding nodes. We offer worst-case response time analysis to systems with ZBCAN. We apply our analysis on a real CAN bus and show that all messages are guaranteed to be schedulable. We offer a probabilistic security analysis of ZBCAN against different attack types. To show its applicability, we evaluate different aspects of our system on a CAN testbed, on a real vehicle's traffic, and directly on a real vehicle's CANbus.

### ZBCAN

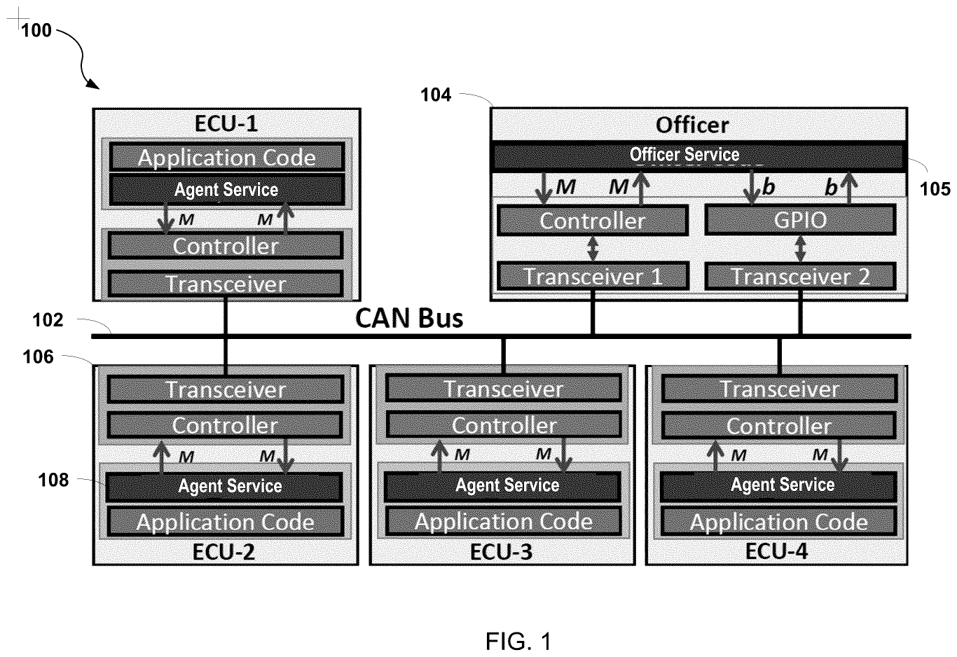

FIG. 1 illustrates an example of a system 100 for securing a controller area network (CAN). The system may herein also be referred to as ZBCAN. The system 100 may include a CAN bus 102. The system 100 may include an officer node 104. The officer node may be an officer electronic control unit (ECU) able to communicate over the CAN bus. The officer node 104 may include an officer service 105 which interacts with the CAN bus 102 via one or more transceivers. The system may further include one or more agent electronic control unit (ECU) 106. The system may further include one or more agent service 108, installed on every ECU. Hereinafter, an officer refers to the officer service 105 and/or an officer ECU 104 with the officer service 105. An agent refers to the agent service 108 and/or an agent ECU 106 with the agent service 104.

The CAN bus 102 may house multiple agents. Each agent may privately agrees on a secret, non-repeating, and unique sequence of inter-frame spaces, called the In BetweeNs (IBNs), with the officer, and then enforces these sequences upon outgoing messages. If the officer detects a message with the wrong IBN, or an unknown ID, it stops it right after the ID portion of the message, thus preventing the message from being received by any ECU. Depending on the officer's setting, it may ignore the message, issue a warning, stop it, or disable its transmitter, among other responses. This way, several attacks could be prevented at once. Namely, error handling attacks rely on a technique called simultaneous transmission, where attackers have to send a message exactly at the same time their victim transmits. With ZBCAN, attackers need to guess the exact IBN value for every message to transmit simultaneously. Similarly, injection and flooding attackers need to guess the correct IBN value for every message. Otherwise, their messages will be stopped by the officer.

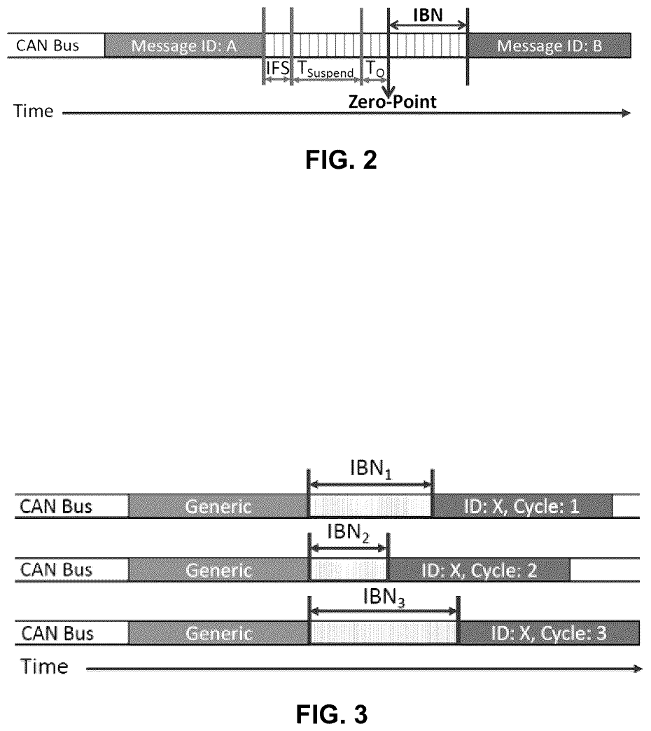

The In BetweeN (IBN). FIG. 2 illustrates an example of a can utilizing zero-byte spacing in between frames. As described herein, the term IBN refers to the spacing between any two consecutive frames, measured from a zero-point. Although this definition is similar to that of the Inter-Frame Spacing (IFS), in most definitions, IFS refers specifically to the three bits following the end of a frame. To avoid confusion, we use the term IBN. Per the standard described in ISO-11898-1, 2015., CAN controllers initiate transmission after sensing the bus idle. This happens by sampling voltage at time intervals equal to one-bit each. As a result, the spacing between the end of one frame and the beginning of another is not continuous but discrete, meaning, it is a multiple of a bit's length, plus a small extra delay caused by clock skews and propagation delay. Therefore, if we can find ways to ignore this small delay we can view the spacing as discrete and measure it using bit-length units or simply bits.

IBN Sequence. FIG. 3 illustrates an example of a running IBN sequence as a message ID signature. To illustrate how to use IBN as a signature, assume that a generic message is currently being transmitted on the bus. Further, assume messages of ID=X have a sequence of endless, secret, and non-repeating IBN values to be followed. When wishing to transmit a new instance of X, the agent of X waits until the ongoing generic message transmission concludes, counts a distance equal to the scheduled IBN (IBNsc) in the sequence, then transmit. The agent does not wait until IBN≥IBNsc but exactly=IBNsc.

Officer. Referring back to FIG. 1, the officer is a trusted node that has the ability to securely store keys and has access to the bus through two channels, one through a CAN controller, and another directly through a GPIO and a CAN transceiver. The GPIO channel serves may important purposes, notable including: (1) accurately measuring the IBN of every message, (2) reading message IDs before their data is delivered, and (3) allowing the officer to inject error frames on demand to stop any message. The officer is connected to the CAN bus in parallel as other nodes. It is not a gate or a bottleneck and causes no delay to messages. Instead, it acts as an observer who can immediately intervene. Its role is to monitor the enforcement of the IBN sequence. If it detects a message violating its IBN sequence or a message ID that is not allowed, it stops it before being received by any ECU. To be able to do so, the officer knows all the allowed IDs on the bus and their secret sequences.

Agent. The agent is an ECU node we wish to protect. It does not require any hardware changes to the ECU. The agent's role is to apply the IBN sequence upon outgoing messages. This sequence is unique per message ID and shared between two parties only: a ZBCAN agent, and the ZBCAN officer. One agent does not know the sequences of any other agent. Alternatively or in addition, the agent could also be integrated into the CAN protocol controller hardware to alleviate any overhead that could be imposed on the ECU by the agent software.

Message Reception. Upon reception, agents do not perform any computations. If a message is received successfully, it is approved by the officer. This way, we eliminate any processing overhead on the receiving side

### IBN Implementation Details

Zero-Point Calibration. The zero-point cannot be the same as last frame's last IFS bit for two reasons. First, nodes operating in the error-passive state have an additional 8-bit suspend-transmission penalty (T_{Suspend}), enforced at the protocol controller's level. If IBN_{sc} is 0, and the zero-point is the last IFS bit, an error-passive node will violate this value. Second, if IBN_{sc} is too low, an ECU with low computational power may not have enough time to initiate transmission in time but after an overhead period (To). To should be measured empirically for every system. Accordingly, as shown in FIG. 2, we set zero-point≥IFS+T_{Suspend}+T_{O}. Measuring T_{O}. Agents are composed of a library and three Interrupt Service Routines (ISRs). To is dependent on the end of frame (EOF) ISR, which is responsible for clearing the transmit buffer, updating the sequence index, checking if there are pending messages to be transmitted, then applying the IBN value at the next transmission. Ideally, the ISR should be able to execute these tasks by the end of T_{Suspend} in FIG. 2. However, some ECUs may take longer. The effective ISR processing time for an ECU could be measured during the system design phase by sending a test message at the end of the EOF ISR (without any IBN), then measuring the distance between the last message on the bus and the test message. The system's T_{O}, should be set to the longest ISRprocessing time of any ECU.

IBNSpan. If the bus is busy and IBN_{sc} is too long, the agent may never find the opportunity to transmit. To prevent this, all IBN values should be kept within a span (IBNSpan) so that any message with IBN_{sc} E IBNSpan is guaranteed to transmit within a window not exceeding its deadline. We use the notation |IBNSpan| to refer to the number of elements (IBN values) in the IBNSpan set.

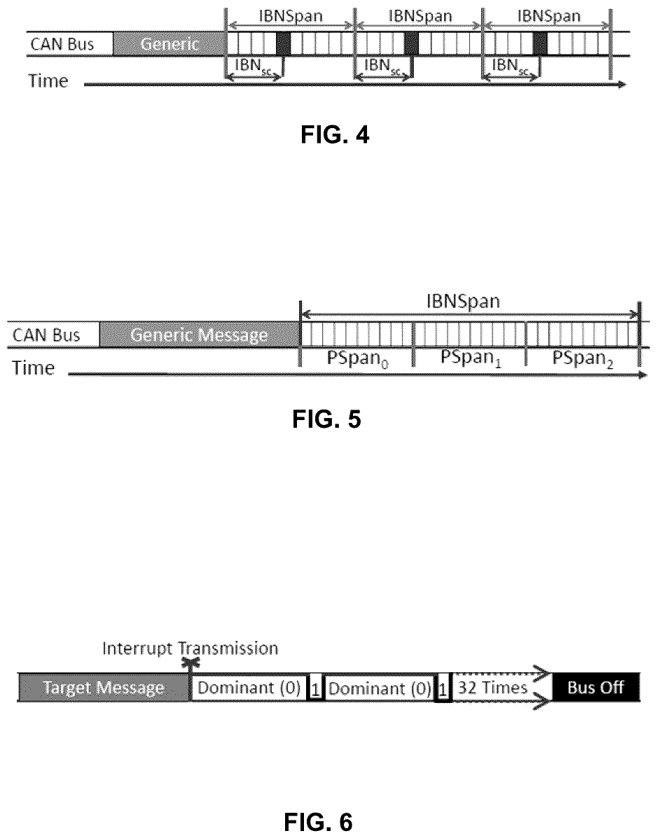

Modulo IBN. FIG. 4 illustrates dividing the timeline into distances=|IBNSpan| for using Modulo IBN instead of Absolute IBN. Since IBN is counted from the last frame on the bus, if a message is generated during a long idle period, it will have to wait until a message appears. Even worse, if all ECUs are also waiting for a message to appear, no messages will transmit. To prevent such problems, starting at the last zero-point, we divide the timeline into slots of length=|IBNSpan|. Instead of having to send the message only at a spacing=IBN_{sc}, we send it at any spacing (d) that satisfies the condition: d mod |IBNSpan|=IBN_{sc}. This way, if a message is generated within an idle period, it waits until the beginning of the next IBNSpan, counts a number of bits=IBN_{sc}, then initiates transmission, as shown in FIG. 4. Beginning from here, the term IBN refers to Modulo IBN.

Priority and IBN. FIG. 5 illustrates an example of dividing IBNSpan into exclusive priority spans. Without ZBCAN, if two messages with IDs 0 and 10 are pending transmission at the same time, they will both go through an arbitration phase that ends in ID: 0 winning and transmitting first. With ZBCAN, if ID: 0's scheduled IBN is 10 b, while ID: 10's scheduled IBN is 0 b, ID: 10 will transmit first, inverting the priority system.

To guarantee that such a scenario does not cause timing deadline violations for time-sensitive messages, we enforce our own priority system. First, we divide IBNSpan further into Nₚᵣi non-overlapping ranges called priority spans (PSpans), each representing one priority level as shown in FIG. 5. Next, we arrange all message IDs in ascending order, based on their deadlines, then group them into Nₚᵣᵢ≥1 priority groups (P_{group}s). Each P_{group} contains one or more message IDs sharing the same PSpan_{group}, where PSpan_{group}∈IBNSpan. P₀ is dedicated PSpan₀ and contains the IDs with the shortest deadlines, while P_{Npri}−1 is dedicated PSpan_{Npri}−1 and contains IDs with the longest deadlines. This way, we guarantee that messages with the shortest deadlines have a higher priority.

Dummy Messages. To prevent IBN inaccuracies due to the inherent clock skew among ECUs, dummy messages of zerobyte length may need to be inserted after long idle periods to force all ECUs to resynchronize.

### Operation

Registration and Sequence Exchange. Each agent starts its operation by an exchange with the officer to establish the first sequence for each ID. This exchange happens only at the beginning of operation. Sequence Usage and Extension. Every agent keeps an indexid for each ID's IBN sequence. With every transmitted message, the agent consumes the bits pointed at by indexid from the sequence and then increments indexid. After the initial sequence exchange, each sequence could be used to generate new sequences throughout the operation without having to re-exchange sequences with the officer.

Officer Policing. If the officer detects a message with a wrong IBN, it interrupts it using an active error right after reading its ID field, preventing its payload from appearing on the bus. Right after the interruption, it issues a warning and resynchronization message with an ID=ID_{warn}, a system parameter. Only the officer is allowed to send this ID. The message contains the violating ID and the indexid of the next expected IBN. Upon reception of a warning message, ECUs read which ID violated its sequence. If an ECU is a transmitter of the violating ID, it updates its indexid to the one in the message. If it is a receiver, it takes note of the possibility of the data being compromised. After N_{warn} successive warnings or if the message has a prohibited or unknown ID, the officer suspends the intruding node.

Errors. If an agent encounters an error while transmitting a message, it should increment its indexid since most errors happen after the ID portion of a message, meaning, after the officer has witnessed and approved the ID and IBN.

Queuing. Since we group every message on the bus into Nₚᵣᵢ priority groups and consider all IDs within a group to have the same priority, we recommend that within each agent, messages in the same priority group share a FIFO queue.

### Disabling Transmitter (Instant Bus-Off)

FIG. 6 illustrates an example of how successively interrupting error frame delimiters 32 times instantly pushes transmitters to the bus-off state. The ECU may be pushed to the bus-off state by targeting a single message. It requires equipment that is able to accurately inject individual bits directly into the bus. Only the officer could do that per our threat model (Sec. 4). The method is as follows. (1) We pick a frame on the bus and wait until a one is being transmitted. Once that happens, we inject a zero. (2) After a single bit, the transmitter detects this error and attempts to send an error frame composed of 6 zeros (flag) and 8 ones (delimiter). (3) After the delimiter starts, we release the bus for a single bit, allowing the one to appear. (4) After the one, we re-inject a zero. Consequently, step (2) repeats. We repeat steps (1-4) 32 times, where the transmitter enters the bus-off state as illustrated in FIG. 6. This process could take as little time as (7*32)+(1*31)=255 b (510 μs on a 500 kbps CAN bus).

Although the authors of proposed the single-frame busoff (SFBO), this technique outperforms it in two ways: (1) SFBO requires ≈5 ms. Our technique requires 512 μs, up to ≈10× faster. (2) SFBO requires automatic re-transmissions to be enabled. As such, an ECU could protect itself by disabling automatic re-transmissions. Our technique does not rely on re-transmissions and hence cannot be escaped once launched.

### Worst-Case Response Time

Several works have analyzed the Worst-Case Response Time (WCRT) in CAN systems. We use the findings of as a starting point. In Equation 1, Rₘ refers to the WCRT of a message, Jₘ refers to the queuing jitter or the longest time between initiating queuing and actually queuing a message, wₘ refers to the queuing delay or the maximum time a message could wait in the queue before initiating transmission, and Cₘ refers to the longest transmission time of message m. Every message ID m should have two metrics defined: (1) Tm to represent the period of a periodic message or the minimum inter-arrival time between two instances of an aperiodic message, and (2) Dm to represent the timing deadline or the maximum allowed delay for the message. A message is schedulable only if Rₘ≤Dₘ.

$${R}_{m} = {J}_{m} + {w}_{m} + {C}_{m} \qquad ( 1 )$$

To calculate the worst case queuing delay wₘ in Equation 1, we use Equation 2. Bₘ refers to the blocking delay or the time message m could wait for a lower priority message, currently in transmission, to conclude. Tₖ refers to the minimum time interval between successive launches of the queuing task of message k, and to τ_{bit} the bit-time.

$${w}_{m}^{n + 1} = max ( {B}_{m} , {C}_{m} ) + {\sum }_{∀ k ∈ h p ( m )} ⌈ \frac{{w}_{m}^{n} + {J}_{k} + {τ}_{bit}}{{T}_{k}} ⌉ {C}_{k} \qquad ( 2 )$$

With ZBCAN, messages wait IBN_{sc} before transmission. The effective transmission time for message m then could be viewed as IBN_{sc,m}+Cₘ. Assuming m ∈ priority group (Pₙ) and PSpanₙ starts at point (Span_{n,beg}), the maximum IBN_{sc,m} message m could wait is G_{max,n}=|PSpanₙ|−1+Span_{n, beg}. As a result, we define ECₘ=G_{max,n}+Cₘ to represent the effective maximum transmission time of m, or the maximum time it could wait if the bus is available plus its actual maximum transmission time Cₘ. Similarly, the effective maximum blocking delay EBₘ includes the lower priority message's waiting time. Since message m shares the same priority level with a whole group, defining which IDs have higher priorities within the group becomes difficult. The worst case is for the longest message to be currently in transmission, for all messages of higher-priority and same-priority groups hp(m) and sp(m), to be pending transmission at the same time, for all higher-priority messages to receive the maximum IBN value for their PSpans, for all messages of the same group, including message m to wait for G_{max,n}, and for m to lose arbitration to every message and transmit last. The worst queuing delay for our system could be represented by Equation 3.

$${w}_{m}^{n + 1} = max ( {EB}_{m} , {EC}_{m} ) + {\sum }_{∀ k ∈ h p ( m ) ⋃ sp ( m )} ⌈ \frac{{w}_{m}^{n} + {J}_{k} + {τ}_{bit}}{{T}_{k}} ⌉ {EC}_{k} \qquad ( 3 )$$

Equations 1 and 3, give us insight on what factors influence the WCRT of a message. We expect for factors such as the bittime (baud-rate), message length, jitter, number of messages and their inter-arrival times, number of priority groups, and |PSpan| to have a direct influence. We also expect for messages in the higher priority groups to have a higher influence on the WCRTs of the system than lower priority groups.

### Priority Grouping

We define the ratio Ratio_{safe}=Rₘ/Dₘ to represent the WCRT of a message m divided by its deadline. To guarantee that time-sensitive messages will not violate their deadlines (schedulable), we map different message IDs to different priority groups such that the condition: Ratio_{safe}≤1 holds for all messages and groups. Grouping should take place during the system design phase and not during operation. To optimize our grouping, we define two objectives. The first is to minimize Ratio safe. Assuming the system has a fixed IBNSpan, then it is obvious that the security of the system drops with every division of this span. Hence, the second objective is to minimize the number of priority groups. The algorithm in table 1 describes how to achieve these objectives. In the algorithm, the term “safe” means Ratio_{safe}≤1.

TABLE 1
Priority Grouping Algorithm

| | |
|---|---|
| 1: | AllIDs ← System ID list |
| 2: | n ← 0 |
| 3: | Ratio_{safe} ← 0 |
| 4: | while Ratio_{safe} ≤ 1 do |
| 5: | System ← Schedulable |
| 6: | while AllIDs ! = Empty && System! = Unschedulable do |
| 7: | Create new group Pₙ |
| 8: | while Pₙ ! = Full & & AllIDs! = Empty do |
| 9: | Add ID to Pₙ |
| 10: | Remove ID from AllIDs |
| 11: | if !( All Pₙ IDs are safe ) then |
| 12: | Remove ID from Pₙ |
| 13: | Add ID back to AllIDs |
| 14: | if Pₙ Empty then |
| 15: | System ← Unschedulable |
| 16: | Return IDs from all groups to AllIDs |
| 17: | Pₙ ← Full |
| 18: | n++ |
| 19: | Ratio_{safe} = Ratio_{safe} + 0.05 |
| 20: | if Ratio_{safe} > 1 && AllIDs! = Empty then |
| 21: | System ← Unschedulable |

### Discretizing IBN Challenges

ZBCAN works by discretizing the spacing between consecutive frames, then controlling this spacing (IBN) to achieve its security goals. Nonetheless, the impact of factors such as the propagation delay on this “discretization process” should be studied to prevent any IBN inaccuracies.

Propagation Delay. Controllers read the value of a bit by taking voltage samples from the bus at bit-lengthed intervals. A bit-time is divided into four segments. The sample point is configurable, and is taken between the third and fourth. For the propagation delay to cause IBN inaccuracies, it needs to exceed the sampling point. Assuming a typical propagation delay of 5 ns, a baud rate of 500 kbps, and an officer's sampling point of 65%, the round trip propagation delay needs to exceed 1300 ns (cable length of >130 m) to constitute a problem. For a typical CAN bus with a 2 to 15 m length, this problem is irrelevant.

Clock Skew and Dummy Messages. Due to the inherent clock skews among ECUs, they gradually lose synch. To counter that, CAN requires all controllers to re-synchronize at the rising edge of every new frame's SOF. In ZBCAN, if the clock skew of one ECU causes it to start transmitting past the sampling point of the officer, it will cause a false positive. To prevent that, we take advantage of CAN's re-synchronization mechanism. Specifically, we define the metric d_{skew} that refers to the minimum spacing between messages that causes any ECU's clock skew to start causing IBN inaccuracies. By inserting a dummy message of zero-byte length at an idle spacing d_{dummy}<d_{skew}, all clocks re-synchronize before the clock skew causes inaccuracies.

### Overhead

A sequence extension operation for a specific ID happens every L_{seq}/log₂(| PSpan|) messages. On the officer's side, the sequences are extended for every message ID in the system. However, on the agent's side, sequences are extended only for the message IDs that the agent transmits.

To function properly, the agents and the officer need a minimum amount of memory to hold variables such as keys, sequences, etc. Specifically, agents require at least (2*L_{sequence})+((3*L_{sequence})+L_{index})*N_{ids-agent} bits, where L_{sequence} refers to the length of the sequence, L_{index} to the length of the index, and N_{ids-agent} to the number of IDs that the agent sends. Similarly, the officer requires at least (2*L_{sequence}*N_{agents})+((3*L_{sequence})+L_{index})*N_{ids-system} bits, where N_{ids-sys} and N_{agents} refer to the number of IDs and number of agents in the system, respectively.

### Security

In the threat model assumed herein, a remote attacker may compromise an ECU through Bluetooth, Internet, or any other remote means. The attacker may execute code but have no control over the protocol controller and cannot alter protocol's rules. The attacker may have no physical access to the bus and hence cannot attach devices with special hardware.

While ECUs communicate on the CAN bus through a CAN controller, the officer can connect directly to the bus. Further, an agent knows only its pre-shared key, which is used to agree on an IBN sequence. The officer, on the other hand, knows the pre-shared keys of all agents. Consequently, a compromised agent cannot read message IDs during transmission, stop messages on demand, alter protocol rules, or establish IBN sequence agreement with other agents, since it does not have the necessary hardware or keys. This limits its abilities to receiving and transmitting full messages and controlling their IBN values, which could be used to push another ECU's messages off sequence, launch message injection (including impersonation, masquerade, etc.), error handling, or flooding attacks. Here, we discuss these attacks.

### Off Sequence Attack

In ZBCAN, each message ID follows a strict IBN sequence. If an attacker is able to guess the scheduled IBN for a target ID once, the officer will update its indexid but the legitimate transmitter will not. Consequently, when it sends its next instance of the message with IBN=IBN_{sc}, it will be off-sequence, since the officer will be expecting an IBN=IBN_{sc+1}. However, since each ID has its own sequence, even if one ID is pushed off sequence, the agent will be able to transmit the rest of the IDs normally. Further, since the officer will stop the first message with unexpected IBN then issue a warning and resynchronization message containing the expected indexid, the legitimate agent will be able to resynchronize.

This method turns a security weakness into a strength, guaranteeing that injections will be detected in 100% of cases, since even a successful injection always results in the legitimate ECU going off sequence and the officer issuing a warning message to all receivers. Further, it is better than having each agent monitor whether its messages are being impersonated then automatically resynchronizing in terms of performance, since agents have to only watch for messages with ID_{warn}, instead of every ID they transmit.

### Injection and Detection Window

Attackers could inject messages with IDs that exist in the network (e.g., masquerade and impersonation) or random IDs that do not necessarily exist (e.g., fuzzing attacks). Assuming a smart attacker that knows the system IDs, their groups and PSpan, ZBCAN offers three probabilistic security guarantees for injection attacks: Individual-Message Detection, Individual-Message Prevention, and Flow Detection.

Individual-Message Detection. Assume a periodic message m with a period T belonging to a priority group with a |PSpan|=n and a scheduled IBN=IBN_{sc}. The probability of guessing IBN_{sc} is 1/n. Within a time period≤T, the legitimate ECU will send its message with the same IBN=IBN_{sc}. Since the officer will be expecting an IBN=IBN_{sc+1}, the injection will be detected within a time window ≥T, except if IBN_{sc+1} is randomly=IBN_{sc}. Since the sequence is generated using a PRF, the probability of IBN_{sc+1} being equal to IBN_{sc} is also 1/n. To generalize, let the detection window (w) be an integer representing the number of periods/cycles of duration T since the injection, the probability of detecting an injection within a window w is represented by Equation 4. Note that P(w)_{det} always tends to 1 given enough cycles.

$${P ( w )}_{d et} = 1 - \frac{1}{{\vert PSpan \vert}^{w + 1}} \qquad ( 4 )$$

Individual-Message Prevention. To prevent an injection, the officer needs to detect it as soon as it appears on the bus, and before it is delivered to the receivers. This means that the probability of prevention Pₚᵣₑᵥₑₙₜ=P(0)_{det}, as shown below:

$${P}_{prevent} = 1 - \frac{1}{\vert PSpan \vert} \qquad ( 5 )$$

The expected number of trials before a successful injection is E(in j)=|PSpan|, not |PSpan|/2, since the officer increments indexid for the sequence with every observed ID instance whether its IBN is accurate or not.

Injection Flow Detection. For a flow of f messages not to be detected, every single message in the flow should pass unnoticed. In other words, an injection flow is detected when any of its messages are detected. Equation 4 could be generalized to quantify this probability to become:

$${P ( w , f )}_{d et} = 1 - \frac{1}{{\vert PSpan \vert}^{w + f}} \qquad ( 6 )$$

Random Injections. ZBCAN allows a message to transmit if the message ID is allowed on the bus and the message is following its Seqid. Since random injections violate both conditions, their rate of prevention and detection is ≈100%.

### Error Handling Attacks

Collision Injection. To inject a collision using simultaneous transmission, one needs to estimate the transmission time of the victim message, send a synch message slightly before its expected arrival, followed by a message of the same ID. With ZBCAN, the attacker cannot randomly inject a high priority message for synchronization or it will be stopped by the officer. Further, the attacker has to accurately guess the scheduled IBN for the victim's message. Finally, with Modulo IBN, the attacker has to guess which |IBNSpan| slot to inject its message. Assuming that the attacker only has to guess IBN, Equation 5 could be applied to estimate a probabilistic lower bound for the prevention rate.

Error Passive. The fastest way to push a victim to the error passive state requires the attacker to cause at least 16 successive collisions, the prevention rate for this scenario is: Pₚᵣₑᵥₑₙₜ≥1−(1/|PSpan|¹⁶).

Bus-Off. The fastest bus-off attack requires the attacker to cause 32 successive collisions. The prevention rate of this scenario is: Pₚᵣₑᵥₑₙₜ≥1−(1/|PSpan|³²).

### Flooding Attacks

ZBCAN prevents flooding by suspending the attacker using the instant bus-off technique. The success of flooding attacks is measured by the drop rate (rate_{drop}) they cause to messages. We define our prevention rate of flooding attacks to be rateₚᵣₑᵥₑₙₜ=1−rate_{drop}. rateₚᵣₑᵥₑₙₜ will differ from a system to another depending on factors such as the busload and the ID allocation of the network more than the |IBNSpan|.

### Choosing |PSpan|

Looking at Equations 4 through 6, we notice that regardless of the value of |PSpan|, injections will always be detected, given enough cycles. Therefore, the value of |PSpan| could be viewed as mainly affecting the detection speed, and the single injection prevention rate. The system designer should initially define their security objectives. A high single injection prevention rate requires a high |PSpan|. However, ZBCAN provides high detection rates, even for small |PSpan| values. For instance, a |PSpan| value as low as 16 b will result in a single injection prevention rate≈93.75%, but a single injection detection rate ≈99.61% within a single cycle. This is already higher than most of the current IDSs detection rates for flows. Meanwhile, its detection rate of a malicious flow composed of only two messages is >99.97% within a single cycle. Within 5 cycles, both the flow and single injection detection rates for the aforementioned scenarios become ≈100%. Outside injection attacks, the same |PSpan| prevents error passive and bus off attacks at a ≈100% rate. To choose a |PSpan| value, a compromise between the security of the system and its performance has to be reached. The busier the system, the smaller the |PSpan| values it could afford.

### Conventions

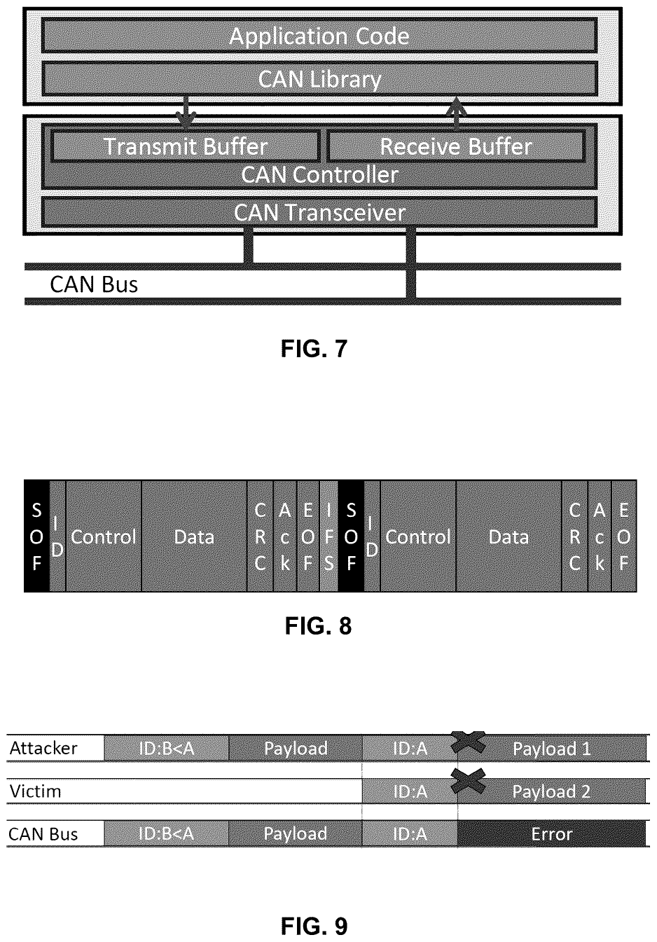

ECU Architecture. As shown in FIG. 7, an ECU is composed of three components: (1) A micro-controller unit running a vehicle control application. (2) A CAN controller to enable CAN communication and enforce protocol rules. (3) A CAN transceiver to encode the CAN controller's bit-stream into the differential voltage signal used on the CAN bus.

CAN Basics. CAN is a broadcast-based bus that uses a publish-subscribe communication model. It uses differential voltage signaling to represent zeros (dominant) and ones (recessive). If a zero and a one are being transmitted by two ECUs at the same time, the zero wins. Messages conclude by sending 7 ones called the End Of Frame (EOF) sequence (FIG. 8). Following EOF, any ECU that wishes to transmit a new frame will have to wait for 3 additional bits called the Inter-Frame Spacing (IFS).

Arbitration and Priority. At the beginning of every CAN message, there is an ID field. Often, an ECU has multiple message IDs, but an ID has only one transmitter. CAN uses the ID as a priority field, with lower ID values having higher priorities. If two ECUs attempt to transmit simultaneously, they first go through an arbitration phase. Each ECU sends one bit at a time and senses the bus; if it is sending one but senses a zero, it stops transmission. Thus, CAN guarantees that beyond arbitration, there is, at most, one transmitter.

Errors. Whenever a CAN message is being transmitted, every ECU is considered a receiver except for the transmitter. Every ECU keeps two error counters, a TEC for errors encountered during transmission, and an REC for errors encountered during reception. CAN defines 5 different errors types for which every ECU should watch. If a transmitter encounters an error, its TEC increases by 8. If a receiver encounters an error, its REC increases by 1. Upon encountering an error, a node signals the error by broadcasting an error frame.

Error States. For fault confinement, CAN enforces a system of error states. By default, ECUs operate in the error-active state. Once their REC or TEC exceeds 127, they enter the error-passive state. If the TEC exceeds 255, they enter the bus-off state, where they stop communicating with the bus.

Injection Attacks. Attacks where a malicious ECU injects messages into the bus. We broadly consider the following as injection attacks: (1) Targeted Injection: Forging and injecting messages that look similar to those transmitted by a specific ECU in charge of certain functions in order to alter those functions. (2) Replay Attacks: Replaying one or more messages transmitted by a different ECU. (3) Random Injection: Forging IDs randomly or semi-randomly to cause damage or to discover hidden message semantics (e.g. fuzzing attacks).

Flooding Attacks. The attacker injects an endless stream of back-to-back high-priority messages to deny other ECUs access to the bus and cause them to drop messages.

Error Handling Attacks. An ever-widening attack surface, these attacks cause a victim ECU to encounter errors using a technique called simultaneous transmission in order to achieve various purposes. For instance by accumulating these errors, attackers could push ECUs to the error passive or bus-off states. These error states could then be exploited to launch persistent DoS attacks, evade voltage intrusion detection systems, or map the network.

Simultaneous Transmission. A technique used by attackers to inject collisions and increase the error counter of a victim. As shown in FIG. 9, the attacker injects a message with the same ID as a target-message exactly at the same time but with a different payload. This causes both the attacker and the victim to experience an error and increase their TEC by 8. For the attacker to synchronize the two messages, they inject one or more synch messages with a higher priority slightly before the message, followed by a message with the same ID.

Other Embodiments. The system 100 may be implemented with additional, different, or fewer components than illustrated. Each component may include additional, different, or fewer components.

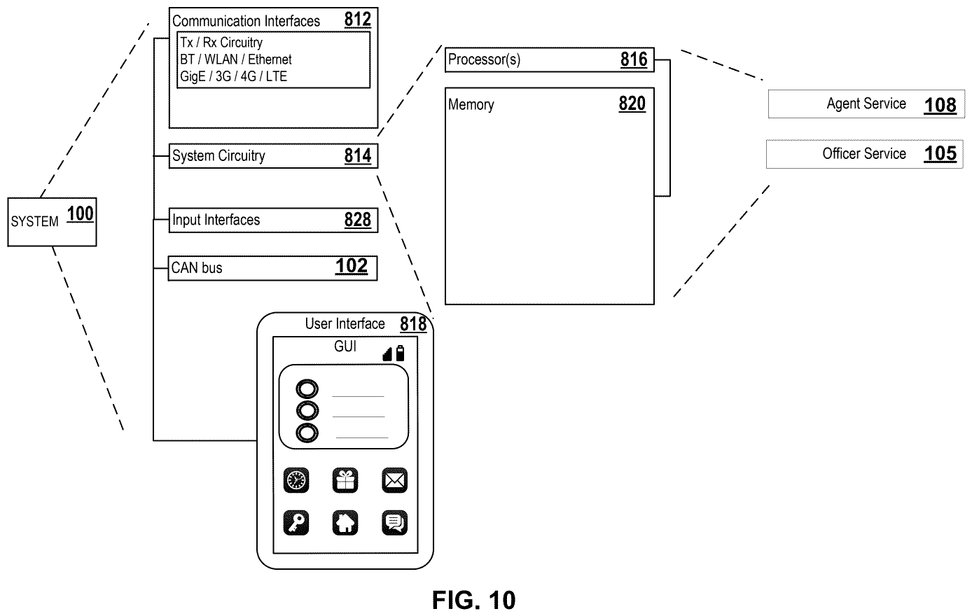

FIG. 10 illustrates a second example of the system 100. The system 100 may include communication interfaces 812, input interfaces 828, CAN Bus, CAN protocol controller hardware, and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. For example, the processor 816 may include the controller of an ECU an officer, or some other node of the CAN bus. The logic may include computer executable instructions or computer code stored in the memory 820 or in other memory that when executed by the processor 816, cause the processor 816 to perform the operations the agent service 108, officer service 105, or any other operations described herein. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the agent service 108, officer service 105, or a combination thereof Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many different ways. In some examples, the system 100 may be implemented with one or more logical components. For example, the logical components of the system 100 may be hardware or a combination of hardware and software. The logical components may include the agent, the officer, or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system, comprising:
a first node configured to broadcast messages on a CAN bus;
a second node configured to listen for the messages on the CAN bus
wherein the first node is configured to include spacing at a start of each of the messages and set a length of the spacing for each of the messages, respectively, according to a predetermined sequence of lengths,
wherein the second node verifies the identify of the node based on the length of the spacing at the start of each of the messages using the predetermined sequence of lengths.

2. The system of claim 1, wherein prior to transmitting a message on the CAN bus, the first node extracts a length value from the sequence of lengths.

3. The system of claim 2, wherein the first nodes creates the spacing by
sensing the bus is idle and identifying a zero-point; and
delaying sending message until the amount of zero bits present on the bus after the zero-point matches the length value extracted from the sequence lengths.

4. The system of claim 1, wherein the second node is configured to
track a current length value in the predetermined sequence of lengths;
identify a message is transmitted on the bus by the first node; and
verify, in response to identification of the message, whether a length of spacing at the beginning of the message is the current length value.

5. The system of claim 4, wherein the second node is further configured to:
determine the length of spacing at the beginning of the message does not match the current length value; and
stop the message from being further transmitted on the bus, issue a warning message on the bus, or a combination thereof.

6. The system of claim 1, wherein the spacing comprises zeros.

7. The system of claim 1, wherein the spacing is positioned after an interframe spacing (IFS) and before the start of the message, respectively.

8. An electronic control unit, comprising
a processor, the processor configured to:
communicate on a CAN bus that is shared with an officer node;
generate a predetermined sequence of lengths that is also shared with the officer node; and
for each message transmitted on the CAN bus, the processor is configured to:
identify a next length in the sequence of lengths; and
delay sending the message until a length of bits is present on the bus equal to the next length.

9. The system of claim 1, wherein the spacing is positioned after an interframe spacing (IFS) and before the start of the message, respectively.

10. The electronic control unit of claim 8, wherein the processor is further configured to:
receive, via the CAN bus, the sequence of lengths generated by the officer node.

11. The electronic control unit of claim 8, wherein the processor is configured to sense the bus is idle and identify a zero-point,
wherein the processor is further configured to delay sending the message until the length of bits is present on the bus equal to the next length in response to identification of the zero-point.

12. An electronic control unit, comprising
a processor, the processor configured to:
communicate on a CAN bus that is shared with a second electronic control unit;
generate a predetermined sequence of lengths that is also accessible by the second electronic control unit; and
monitor the CAN bus for messages;
in response to identifying a message being transmitted on the BUS:
identify a next length in the sequence of lengths; and
determine a length of bits between the end of the previous message and the identified message is not equal to the next length; and
prevent the message from being sent on the CAN bus in response to the length of bits not being equal to the next length.

13. The electronic control unit of claim 12, wherein processor is configured to
determine a length of bits between the end of the previous message and the identified message is equal to the next length; and
permit transmission of the message on the CAN bus in response to the identified message being equal to the next length.

14. The electronic control unit of claim 12, wherein the bits comprises zeros.

15. The electronic control unit of claim 12, wherein to prevent the message from being sent on the CAN bus, the processor is further configured to:
stop the message from being further transmitted on the bus, disable a transmitter of the second ECU, or a combination thereof.

16. The electronic control unit of claim 12, wherein the length of bits is measured after an interframe spacing (IFS) and before a start of the message.
